(19) United States
(12) Patent Application Publication
(10) Pub. No.: US 2015/0355707 A1
(43) Pub. Date: Dec. 10, 2015

(54) SENSOR ASSEMBLY FOR DETECTING OPERATOR GESTURES IN VEHICLES

(71) Applicant: HUF HÜLSBECK & FÜRST GMBH & CO. KG, Velbert (DE)

(72) Inventors: Mirko Schindler, Velbert (DE); Bernd Gerdes, Essen (DE); Bernd Ette, Wolfsburg (DE)

(21) Appl. No.: 14/760,921

(22) PCT Filed: Jan. 7, 2014
(86) PCT No.: PCT/EP2014/050106

§ 371 Date: Jul. 14, 2015

(30) Foreign Application Priority Data
Jan. 18, 2013 (DE) 10 2013 100 521.7

(51) Int. Cl. G06F 3/00; H04N 13/02; G06K 9/00; G06F 3/01

(52) U.S. Cl. CPC G06F 3/005; G06F 3/017; H04N 13/0253; G06K 9/00335

(57) ABSTRACT

The invention relates to a sensor device (2) for a motor vehicle (1). The sensor device has a light source (10) and a detection device (20), said detection device is formed using an array of optical pixels. The light source (10) and the detection device (20) are coupled to a control and evaluation device (30) which activates the light source (10) to emit light pulses and activates the detection device to carry out the detection process. The control and evaluation device (30), the detection device (20) and the light source (10) interact as a time-of-flight camera (ToF camera), allowing spatial range data to be detected. The control and evaluation device (30) has multiple activation schemes for different groups of pixels of the detection device (20), a first activation scheme (idle mode) activating and evaluating a portion of pixels as a first pixel group and a second activation scheme (active scheme) activating and evaluating a larger portion of pixels as a second pixel group. Depending on the results of the evaluation according to the first activation scheme, the control and evaluation device switches to an activation according to the second activation scheme.

The invention relates to sensor assemblies that are used for the optically-supported detection of operator gestures or operator activities in motor vehicles.

In particular, the invention relates to sensor assemblies that can detect and evaluate information resolved in time and space in order to discern the operating intent of the user.

Optical methods are known in the prior art that discern actuations in reaction to an evaluation of image information and subsequently trigger e.g. switching procedures. For example, this includes automated video evaluations of monitoring systems that read out patterns or movements from individual images, or a sequence of images. Furthermore, numerous other optically-supported systems are known, light barriers or brightness sensor being among the most basic. However, optical systems of greater complexity frequently use an array of optically-sensitive detection units, generally termed pixels, that record optical information in parallel, for example in the form of a CCD array.

DE 10 2008 025 669 A1 discloses an optical sensor that detects a gesture, and a closing element of a vehicle is then automatically moved.

WO 2008/116699 A2 addresses an optical sensor chip and relates to an optical anti-pinch sensor device to monitor a window pane, sliding door, or a tailgate in a motor vehicle.

WO 2012/084222 A1 discloses an optical sensor for actuating and monitoring a closing element.

Since gesture control is gaining ever greater acceptance in various technical fields, attempts were also made to use such exclusively optical systems to discern operator intent in motor vehicles. With these systems, the detection of operations by means of capacitive systems still predominates.

DE 10 2011 089 195 A1 discloses a system for the contact-free detection of objects and operator gestures with an optically-supported device of a similar kind which can also be used for the invention. However, such systems are demanding in regard to energy consumption; continuous monitoring of access control in the vehicle's surroundings is problematic given the energy requirement.

The object of the invention is to provide an optically-supported and energy-optimized system for controlling operation in access systems for vehicles.

The object is achieved with a device having the characteristics of claim 1.

The system according to the invention uses optical detection, although not exclusively image detection. A pixel array is used with a timed activation which permits distance detection and can detect object movement by analyzing the distance information over time. Detection devices are known that detect pixel-related location information, in particular a distance from the sensor or detection device. These systems are for example designated “Time-of-Flight” systems or also “3D imagers” or “range imagers”, depending on the evaluation method used. The areas of application of such systems are in the field of industrial automation, safety engineering and the automotive sector. In an automobile, 3-D sensors are used in lane assist systems, for pedestrian protection or as parking assistance. Such concepts of triangulation as well as interferometry and Time-of-Flight (ToF) measurement can be implemented with optical sensors.

The system according to the invention has an array of light-sensitive pixels as well as a light source. The light source is arranged in the area of the array of sensitive pixels, for example at a slight distance from the array. A control circuit controls both the operation of the light source as well as the operation of the pixel array.

In this context, reference is made to developments thereof that describe the technical concepts and their realization in detail, in particular in the dissertation “Photodetektoren and Auslesekonzepte für 3D-Time-of-Flight-Bildsensoren in 0.35 μm-Standard-CMOS-Technologie” [Photodetectors and readout concepts for 3-D Time-of-Flight image sensors in 0.35 standard CMOS technology], Andreas Spickermann, Faculty of Engineering Sciences at the University of Duisburg-Essen, 2010.

Furthermore, reference is made to the publication “Optimized Distance Measurement with 3D-CMOS Image Sensor and Real-Time Processing of the 3D Data for Applications in Automotive and Safety Engineering”, Bernhard Konig, Faculty of Engineering Sciences at the University of Duisburg-Essen, 2008.

The above works describe the concept and realization of useful optical sensor systems; reference is therefore made in this application to their disclosure, and they will only be explained to clarify those aspects relevant to understanding the application.

The invention relates to a sensor array that uses the Time-of-Flight (ToF) method which will therefore be briefly explained at this juncture.

In the ToF method, a space is illuminated with a light source, and the propagation time of the light reflected by an object in the space is recorded by a surface sensor. The light source and sensor should be arranged as close to each other as possible. The distance between the sensor and object can be determined from the linear relationship of the light propagation time and speed of light. To measure the time delay, synchronization must exist between the light source and sensor. The methods can be optimized by using pulsed light sources since short light pulses (in the ns range) enable efficient suppression of background light. In addition, by using pulsed light, potential ambiguities are avoided in determining the distance as long as the distance is sufficiently large.

On the one hand, the light source is operated in a pulsed manner in this approach. On the other hand, the detection unit, i.e., the pixel array, is configured to be pulse-sensitive, i.e., the integration of the individual pixels is synchronized in time with the light source, and the duration of integration is limited. By comparing the results with different integration times, the effects of background light in particular can be calculated out.

It is pertinent that this detection method is not an image-based detection method. Each pixel determines distance information which occurs by detecting light over time. When a pixel array is used, a matrix of distance values exists that permits object movements to be interpreted and tracked during cyclical detection.

According to the invention, a distinction is drawn between different operating modes of the detection device. Groups of pixels are formed that can be activated for detection separately by the control device.

When a subgroup of the pixels is activated while simultaneously deactivating the other pixels, energy savings occurs.

According to the invention, the individual pixels of the array are combined into different groups, and one of the groups for example comprises all the pixels, and a second group can comprise only a part of the pixels. When to switch to a specific mode is determined from the evaluation of the pixel signals. This approach is termed the activation scheme in the context of this application. An activation scheme can hence comprise pixel selection and the associated control parameters (such as the time parameters).

If only a subgroup of the pixels is operated, they are activated and evaluated in the envisioned manner to determine the distance values of each of the individual pixels. The subset of pixels can be activated differently, especially with different time parameters, than activating when all the pixels are operated. If for example in a rectangular pixel arrangement on a pixel array only the group of pixels located at the outer edge is activated, this is sufficient to detect an approach of a user into the detection area of the sensor arrangement. Although the precision of this detection is not equivalent to detection with the entire number of pixels, that is unnecessary however since all the pixels are activated if improvement is needed.

If for example the aforementioned pixel frame is kept active in sleep mode, detection with this pixel frame can occur at greater intervals than inactive mode, and a rougher evaluation occurs of whether a potential approach by a user exists. If this is the case, the sensor arrangement is transferred into a different operating mode—active mode—in which a different pixel group such as all the pixels is activated and evaluated. The frequency at which the evaluation occurs can also be different in the different operating modes.

As already mentioned above, the pixel groups can have overlaps, and one pixel group can entirely encompass another pixel group.

An evaluation scheme always belongs to each of the activation schemes. The evaluation scheme can be adapted in regard to the activation scheme.

If such a sensor arrangement is used in a vehicle to monitor the exterior and to control entrance into a vehicle, the activation of a subset of the pixels is sufficient to determine at least the approach of a user. If the user is within this region, this is detected by characteristic signal changes in the distance values in a majority of the pixels. Precise gesture recognition is not possible with the reduced resolution of the pixel array in sleep mode; this is however also not necessary. The general recognition of a user's approach leads to a change in activation by the control device such that a different pixel group, possibly the pixel group comprising the first pixel group, is activated. The gestures of movement can be detected with increased resolution.

In a preferred embodiment of the invention, the pixels lying in the outer regions, such as the edge of the pixel array, are activated as the first group by a pixel array. By means of this measure, the spatial extent and difference between the signals with a simultaneously reduced number of pixels is optimally exploited.

In another embodiment of the invention, the query frequency in the operating mode with the first pixel group, sleep mode, is reduced relative to the query frequency at which the expanded pixel group is operated for gesture recognition in active mode. According to the invention, it is sufficient if the detection of the approach of a user is checked with less frequency than the fine resolution detection of user gestures.

The selected pixel groups on the sensor array can also be arranged in a manner that varies over time. For example, one fourth of the sensor surface can be alternately queried cyclically such that the number of pixels is basically the same during each query in low-power mode; however, not always the same pixels are used for this power-saving query. In the aforementioned example when one fourth of the pixels are used, the sectors of fourths can for example be varied cyclically so that each pixel is only activated during each fourth query.

It is pertinent that by activating a pixel subgroup of the array, the sensor itself is operated in a different operating mode as a low-power activation sensor. This procedure according to the invention has structural advantages in comparison to the use of a separate activation sensor since fewer components are required.

According to the invention, the detection which occurred in power saving mode, even if it is a first, rough detection, can also be used for the subsequent, fine resolution detection of gestures.

The invention will now be explained in more detail using an exemplary embodiment.

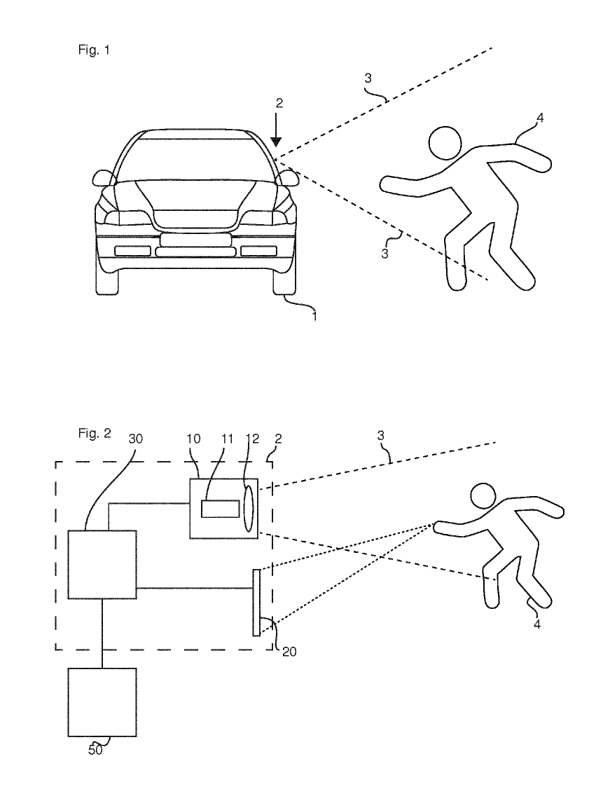

FIG. 1 schematically illustrates the situation of use of a detection device according to the patent in a vehicle;

FIG. 2 shows the active components of a detection device in a schematic representation;

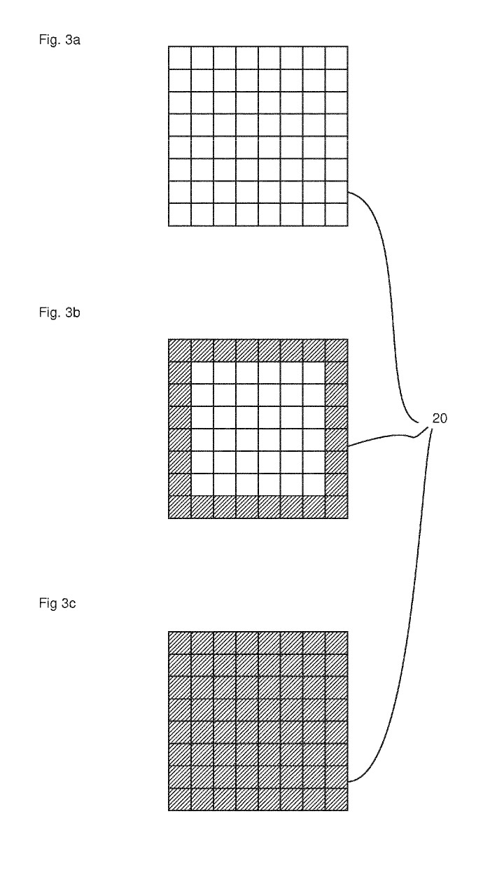

FIG. 3A to 3C schematically illustrate a sensor field in different operating modes.

As shown in FIG. 1, a vehicle 1 is equipped with a sensor device 2 according to the invention. The sensor device 2 detects activities and movements in a detection range 3 indicated by lines in this case. A user 4 who approaches the vehicle has the opportunity of performing gestures within the detection range 3 to invoke vehicle functions. In the embodiment shown here, the detection device 2 is housed in the side of the vehicle, for example in the B-column. Such a detection device can however also be arranged at any other location in the vehicle, in particular in the rear region or the front region.

FIG. 2 shows the components of the detection device in a schematic representation. In this representation, the vehicle 1 is not shown so that the depiction will not be cluttered.

The device 2 has a light source 10 which is formed in this example by a laser diode 11 and an expanding lens system 12. The lens system 12 expands the beam cross-section to form a wide detection area 3 which a user 4 can enter and in which he can perform gestures. This can be for example a simple plastic lens system such as a Fresnel lens.

A detection array 20 is arranged adjacent to the light source aligned with the sensitive region facing the detection region 3. The array 20 contains columns and lines of sensitive pixels and is configured in this example as a CCD array. Both the light source 10 as well as the array 20 are coupled to a control device 30 which enables clocked and time-controlled operation of the light source and the detection device. If the light source is activated to transmit a light pulse and the pixel array is activated to detect, the individual pixels integrate the incident light energy. The charges of each pixel which are then available after integration are evaluated in the control device such that a detection value characteristic of the integration time period is generated for each pixel.

By means of this scheduled and synchronized activation of both the light source 10 as well as the detection device 20, detection of the light propagation time and hence distance detection is possible for each pixel of the detection device 20. In regard to the precise functions, reference is made to the subject matter disclosed in the aforementioned publications, especially the known Time-of-Flight devices.

In an example, FIG. 2 shows that part of the light emitted by the light source is scattered or reflected by the hand of the user 4 and falls on the detection device 20. In practice, the light information of course does not originate solely from a single point which scatters or reflects the light; rather, all of the light received from all the visible points is integrated. The surroundings also contribute to the strength of detection. However, algorithms and sensor arrangement operating methods are known by means of which the surrounding light can be largely calculated out. In particular, a plurality of images can be taken in quick sequence with different time parameters in order to calculate out the background light. Such a detection can in particular occur with different integration times in order to eliminate background light influences. If for example the light pulse is transmitted with an unchanging duration but the length of the integration is varied, the background influences have a linear relationship with the integration time, whereas the influences arising from the light pulse only exist for the duration of the light pulse.

The control and evaluation device 30 records the contact information and recalculates it in an array of distance information. A 3-D map of the surroundings can be generated thereby. 3-D information of spatial changes and object movements within the detection region 3 can be detected by means of a temporal sequence of manual controls. For example, the swinging of a hand of a user 4 can be detected. The control device 30, and the entire detection device 2 through the control device 30, is coupled to a central control device 50 of the motor vehicle. Gestures can be recognized by means of a library in the control and evaluation device 30, or a temporal sequence of 3-D spatial data is fed to the central control device 50 to be evaluated there. The central control 50 then initiates the triggering of the function of the motor vehicle depending on the detected data, such as the lowering of a side window or the opening of a door.

As shown in FIG. 1, it is necessary for a user 4 to be in a detection range 3 of the detection device 2 in order to trigger an actuation. During the majority of its life, a vehicle is standing still waiting to be started. During these times, it is very important to minimize the output or power requirement of all the devices in vehicles.

FIGS. 3A, 3B and 3C show a schematic representation of a CCD array that can be operated with the Time-of-Flight method for detection according to the invention. In this example, the array consists of a square chip with 8 columns and 8 lines. This is only a value for illustration; in practice, a significantly higher resolution is possible. On the other hand, such a chip does not need to possess the extent of resolutions of an optical chip for detail-rich images to enable gesture detection according to the invention. The number of 1024 pixels already allows a differentiated evaluation of user gestures since repeated distance measurements are performed for each of these pixels, and a profile of movement is determined over a sequence in time. Reliable gesture detection is still feasible even with a fewer number of pixels.

FIG. 3A shows a state of the sensor array 20 in which all of the pixels are completely turned off, i.e., inactive. Movement recognition or gesture recognition is not possible with such a pixel field. This state is assumed when the vehicle is e.g. completely turned off, or e.g. when the vehicle has not been accessed for several days.

FIG. 3B shows the state of the vehicle in the first operating mode, sleep mode, according to the invention. The pixel arrangement is connected such that a first group of active pixels occupies the outer frame of the pixel arrangement. An inner field of the pixels remains currentless in this operating mode. The pixels with the hatching in the outer frame are queried at a first clock frequency such as 10 Hz. Since a reduction in the number of pixels is also associated with a reduction in the resolution and detection precision, the supplied data is less detailed. In this operating mode, only 28 pixels are operated instead of the 64 pixels as shown in the example, and possibly at a reduced query frequency. According to the invention in this exemplary embodiment, an independent evaluation scheme is provided for this operating mode. The evaluation can be generally carried out by adapting pattern schemes and/or also e.g. by neural networks. Signal patterns are e.g. saved in the control device 30 which allow detection and evaluation with this reduced pixel group. For example, this saved pattern library for signal sequences over time can also be configured to detect the pattern of a human body. Precise gesture detection is not possible in this operating mode; however, it is possible with this exemplary embodiment to distinguish the approach of a human from the approach of other bodies such as animals or other objects.

Alternately, much simpler evaluation schemes can also be used. For example, the signal change over time which indicates the approach of any object can be used to switch to active mode. One simple option is also to use the average of the signals of the active pixels, and then use a change over time and values around a threshold within a given period as a trigger.

In the event that detection with a reduced number of pixels according to the activation scheme of the pixels in FIG. 3B indicates that a human is within the detection range, the second pixel group, i.e. the interior of the sensor field, is added as shown in FIG. 3C. Detection with full resolution is then available for gesture recognition. This higher performance operation (active mode) is accordingly activated when a prior evaluation has satisfied the activation conditions.

If no gesture control is detected within a certain time window and if the object leaves the detection range, the device returns to the first detection mode in which power consumption is reduced.

It is pertinent for the activation query to occur by means of the same sensor field as the actual sensitive and detail-rich subsequent evaluation.

The switch between operating modes is performed by the control device 30 using the detected information. However, the control device 30 can also be supplied with a signal from the central vehicle device 50 that indicates the change in other vehicle parameters. For example, all of the sensors can be activated for a specific period when a remote control transmitter is actuated by a user. Furthermore in the event that for example the vehicle is locked up, there can be an intentional switch to power-saving mode.

Apart from that, the activation schemes shown in FIG. 3A to 3C for pixel detections are exemplary in nature. Instead of the pixel frame, line-wise or sector-wise activations can occur. It is furthermore possible to activate alternating pixel fields in order to ensure an even utilization of the detection units. These sectors or pixel groups can be activated cyclically.

It is pertinent to the invention that the pixel fields of a 3-D detection device for access to a vehicle can be activated in groups that enable a low-power mode for detection and activation recognition.

1. A sensor device for a motor vehicle, said sensor device comprising:
a light source;
a detection device having an array of optical pixels; and
a control and evaluation device coupled to the light source and the detection device, said control and actuation device activating the light source to emit light pulses, activating the detection device to detect light from the light source, and evaluating signals of generated by the pixels of the detection device, wherein the control and evaluation device, the detection device, and the light source interact as a Time-of-Flight camera (ToF camera), allowing spatial range data to be detected, and the control and evaluation device has a plurality of activation schemes for different groups of pixels of the detection device, wherein in a first activation scheme (idle mode), the control and activation device activates and evaluates a subset of pixels as a first pixel group, wherein in a second activation scheme (active scheme), the control and activation device activates and evaluates a larger portion of pixels as a second pixel group, wherein depending on the results of the evaluation according to the first activation scheme, the control and evaluation device switches to activation according to the second activation scheme.

2. The sensor device according to claim 1, wherein the second pixel group comprises the first pixel group.

3. The sensor device according to claim 1, wherein the array of optical pixels extends in a plane, and wherein the first pixel group is being formed from the outermost pixels of the array.

4. The sensor device according to claim 1, wherein the array of optical pixels extends in a plane and wherein a plurality of first pixel groups are activatable that are alternatively activatable by the control and evaluation device such that alternating subsets of the pixels of the detection device are activated according to first activation scheme.

5. The sensor device according to claim 1, wherein according to the first activation scheme, an activation is repeated with a first detection frequency f1, and wherein according to the second activation scheme, the activation is repeated with a second, higher detection frequency f2.

6. The sensor device according to claim 1, wherein the control and evaluation device uses an associated first evaluation scheme to evaluate the data of the detection device upon activation according to the first activation scheme, and wherein the control and evaluation device uses an associated second evaluation scheme to evaluate the data of the detection device upon activation according to the associated second activation scheme.

7. A method of detecting gestures, said method comprising:
emitting at least one light pulse from a light source;
detecting a reflection of the at least one light pulse using an array of optical pixels detecting light, said at least one light pulse activating pixels of said array of optical pixels;
generating signals corresponding to the reflection of the at least one light pulse detected by each activated pixel of the array of optical pixels;
evaluating the signals of a subset of pixels as a first group in a first activation scheme (idle mode);
depending on the results of the evaluation according to the first activation scheme, evaluating a larger portion of pixels as a second pixel group in a second activation scheme (active scheme).

8. The method according to claim 7, wherein the second pixel group comprises the first pixel group.

9. The method according to claim 7, wherein the array of optical pixels extends in a plane, and wherein the first pixel group is being formed from the outermost pixels of the array.

10. The method according to claim 7, wherein the array of optical pixels extends in a plane and wherein a plurality of first pixel groups are activatable that are alternatively activatable by a control and evaluation device such that alternating subsets of the pixels are activated according to first activation scheme.

11. The method according to claim 7, wherein according to the first activation scheme, an activation is repeated with a first detection frequency f1, and wherein according to the second activation scheme, the activation is repeated with a second, higher detection frequency f2.

12. The method according to claim 7, wherein a control and evaluation device uses an associated first evaluation scheme to evaluate the signals upon activation of the pixels according to the first activation scheme, and wherein the control and evaluation device uses an associated second evaluation scheme to evaluate the signals upon activation of the pixels according to the associated second activation scheme.
